(19) United States
(12) Patent Application Publication
(10) Pub. No.: US 2026/0147485 A1
(43) Pub. Date: May 28, 2026

(54) COMPUTATIONAL STORAGE SYSTEM, METHOD OF OPERATING THEREOF, AND ELECTRONIC SYSTEM

(71) Applicant: Yangtze Memory Technologies Co., Ltd., Wuhan (CN)

(72) Inventors: Dongrun Qin, Wuhan (CN); Tianyi Wang, Wuhan (CN); Mo Cheng, Wuhan (CN)

(21) Appl. No.: 19/062,663

(22) Filed: Feb. 25, 2025

(30) Foreign Application Priority Data
Nov. 25, 2024 (CN) 202411698879.1

(51) Int. Cl. G06F 3/06

(52) U.S. Cl. CPC G06F 3/0619; G06F 3/0659; G06F 3/0679

(57) ABSTRACT

According to one aspect of the present disclosure, a computational storage system is provided. The computational storage system may include a first memory. The computational storage system may include a computing processing component configured to execute a program. The computational storage system may include a controller coupled to the first memory. The controller may be configured to receive a first command. The controller may be configured to, in response to the first command, configure a respective storage area in the first memory for data in a process of executing the program by the computing processing component. The controller may be configured to perform a power-loss protection operation on the storage area that requires power-loss protection when the computational storage system is in a state of power loss based on information carried in the first command indicating that power-loss protection on the respective storage area is required.

### CROSS-REFERENCE TO RELATED APPLICATIONS

This application claims the benefit of priority to Chinese Application No. 202411698879.1, filed on Nov. 25, 2024, which is incorporated herein by reference in its entirety.

### TECHNICAL FIELD

The present disclosure relates to the field of semiconductor technologies, and in particular, to a computational storage system, a method of operating thereof, and an electronic system.

### BACKGROUND

Semiconductor memories may be roughly divided into two categories, depending on whether they retain stored data when in a state of power loss; these two types of semiconductor memories are: volatile memory and non-volatile memory, where volatile memory loses stored data when in a state of power loss, and non-volatile memory retains stored data when in a state of power loss.

### SUMMARY

According to one aspect of the present disclosure, a computational storage system is provided. The computational storage system may include a first memory. The computational storage system may include a computing processing component configured to execute a program. The computational storage system may include a controller coupled to the first memory. The controller may be configured to receive a first command. The controller may be configured to, in response to the first command, configure a respective storage area in the first memory for data in a process of executing the program by the computing processing component. The controller may be configured to perform a power-loss protection operation on the storage area that requires power-loss protection when the computational storage system is in a state of power loss based on information carried in the first command indicating that power-loss protection on the respective storage area is required.

In some implementations, the controller may be configured to update information related to a power-loss protection capability of the computational storage system based on information about a current power-loss protection capability of the computational storage system in log information of the computational storage system and the information carried in the first command indicating that power-loss protection on the respective storage area is required.

In some implementations, the controller may be configured to receive a second command. In some implementations, the controller may be configured to update the information related to the power-loss protection capability of the computational storage system based on information carried in the second command that is related to an area range that requires power-loss protection in the storage area that requires power-loss protection. In some implementations, the controller may be configured to perform the power-loss protection operation on the respective storage area based on the information carried in the second command that is related to the area range that requires power-loss protection in the storage area that requires power-loss protection and priority.

In some implementations, the information related to the area range that requires power-loss protection in the storage area that requires power-loss protection may include an offset value of a starting address of an area that requires power-loss protection in the storage area that requires power-loss protection relative to a starting address of the storage area, and a size of data that can be stored in the area that requires power-loss protection in the storage area that requires power-loss protection.

In some implementations, the controller may be configured to receive a third command based on the execution of the program being completed. In some implementations, the third command may carry information indicating that the respective storage area does not require power-loss protection. In some implementations, the controller may be configured to update the information related to the power-loss protection capability of the computational storage system based on corresponding information carried in the third command about whether the respective storage area configured for data in the process of executing the program requires power-loss protection having changed compared to the first command.

In some implementations, the controller may be configured to receive a fourth command. In some implementations, the fourth command may instruct to obtain the power loss protection capability of the computational storage system. In some implementations, the controller may be configured to update the information related to the power loss protection capability of the computational storage system based on time required to execute the program and an aging speed of a power loss protection hardware of the computational storage system carried in the fourth command.

In some implementations, the controller may be configured to receive a fifth command. In some implementations, the fifth command may instruct to set a condition for triggering an asynchronous event to be that the power loss protection capability of the computational storage system is lower than a preset threshold. In some implementations, the controller may be configured to receive a sixth command. In some implementation, the sixth command may instruct to request the asynchronous event. In some implementations, the controller may be configured to send an asynchronous event report based on the power loss protection capability of the computational storage system being lower than the preset threshold.

In some implementations, the controller may be configured to receive a seventh command. In some implementations, the controller may be configured to in response to the seventh command, perform an update operation on the information about whether the respective storage area in the first memory configured for data in the process of executing the program requires power loss protection.

In some implementations, the computational storage system may include a second memory coupled to the controller. In some implementations, the controller may be configured to, when the computational storage system is in a state of power loss, store data in the storage area that requires power-loss protection into a first area of the second memory based on the information carried in the first command indicating that power-loss protection on the respective storage area is required.

In some implementations, the controller may be configured to, when power of the computational storage system is restored, store the data that is stored into the first area of the second memory into the first memory or into a second area of the second memory.

In some implementations, the computational storage system may include a non-volatile namespace including the second memory. In some implementations, the computational storage system may include a computing namespace including the computing processing component. In some implementations, the computational storage system may include a sub-system local memory namespace including the first memory.

According to another aspect of the present disclosure, an electronic system is provided. The electronic system may include a host configured to send a first command. The electronic system may include a computational storage system coupled to the host. The computational storage system may include a first memory. The computational storage system may include a computing processing component configured to execute a program. The computational storage system may include a controller coupled to the first memory. The controller may be configured to receive the first command. The controller may be configured to, in response to the first command, configure a respective storage area in the first memory for data in a process of executing the program. The controller may be configured to perform a power-loss protection operation on the storage area that requires power-loss protection when the computational storage system is in a state of power loss based on information carried in the first command indicating that power-loss protection on the respective storage area is required.

In some implementations, the host may be configured to determine whether the respective storage area requires power-loss protection based on information about a power-loss protection capability of the computational storage system in log information of the computational storage system and a degree-of-importance of data to be stored in the respective storage area. In some implementations, the controller may be configured to update information related to a power-loss protection capability of the computational storage system based on information about a current power-loss protection capability of the computational storage system in the log information of the computational storage system and the information carried in the first command indicating that power-loss protection on the respective storage area is required.

In some implementations, the host may be configured to send a second command. In some implementations, the controller may be configured to receive the second command. In some implementations, the controller may be configured to update the information related to the power-loss protection capability of the computational storage system based on information carried in the second command that is related to an area range that requires power-loss protection in the storage area that requires power-loss protection. In some implementations, the controller may be configured to perform the power-loss protection operation on the respective storage area based on the information carried in the second command that is related to the area range that requires power-loss protection in the storage area that requires power-loss protection and priority.

In some implementations, the host may be configured to send a third command based on the execution of the program being completed. In some implementations, the third command carries information indicating that the respective storage area does not require power loss protection. In some implementations, the controller may be configured to receive the third command. In some implementations, the controller may be configured to update the information related to the power loss protection capability of the computational storage system based on corresponding information carried in the third command about whether the respective storage area configured for data in the process of executing the program requires power loss protection having changed compared to the first command.

In some implementations, the host may be configured to send a fourth command. In some implementations, the fourth command may instruct to obtain the power loss protection capability of the computational storage system. In some implementations, the controller may be configured to receive the fourth command. In some implementations, the controller may be configured to update the information related to the power loss protection capability of the computational storage system based on time required to execute the program and an aging speed of a power loss protection hardware of the computational storage system carried in the fourth command.

In some implementations, the host may be configured to send a fifth command. In some implementations, the fifth command may instruct to set a condition for triggering an asynchronous event to be that the power loss protection capability of the computational storage system is lower than a preset threshold. In some implementations, the host may be configured to send a sixth command. In some implementations, the sixth command may instruct to request the asynchronous event. In some implementations, the controller may be configured to receive the fifth command and the sixth command. In some implementations, the controller may be configured to send an asynchronous event report based on the power loss protection capability of the computational storage system being lower than the preset threshold.

In some implementations, the host may be configured to send a seventh command. In some implementations, the controller may be configured to receive the seventh command. In some implementations, the controller may be configured to, in response to the seventh command, perform an update operation on the information about whether the respective storage area in the first memory configured for data in the process of executing the program requires power loss protection.

According to a further aspect of the present disclosure, a method of operating a computational storage system is provided. The method may include receiving a first command. The method may include, in response to the first command, configuring a respective storage area in a first memory for data in a process of executing a program by a computing processing component. The method may include performing a power-loss protection operation on the storage area that requires power-loss protection when the computational storage system is in a state of power loss based on information carried in the first command indicating that power-loss protection on the respective storage area is required.

In some implementations, the method may include updating information related to a power-loss protection capability of the computational storage system based on information about a current power-loss protection capability of the computational storage system in log information of the computational storage system and the information carried in the first command indicating that power-loss protection on the respective storage area is required.

In some implementations, the method may include receiving a second command. In some implementations, the method may include updating the information related to the power-loss protection capability of the computational storage system based on information carried in the second command that is related to an area range that requires power-loss protection in the storage area that requires power-loss protection. In some implementations, the method may include performing the power-loss protection operation on the respective storage area based on the information carried in the second command that is related to the area range that requires power-loss protection in the storage area that requires power-loss protection and priority.

In some implementations, the information related to the area range that requires power-loss protection in the storage area that requires power-loss protection may include an offset value of a starting address of an area that requires power-loss protection in the storage area that requires power-loss protection relative to a starting address of the storage area. In some implementations, the information related to the area range that requires power-loss protection in the storage area that requires power-loss protection may include a size of data that can be stored in the area that requires power-loss protection in the storage area that requires power-loss protection.

In some implementations, the method may include receiving a third command based on the execution of the program being completed. In some implementations, the third command carries information indicating that the respective storage area does not require power loss protection. In some implementations, the method may include updating the information related to the power loss protection capability of the computational storage system based on corresponding information carried in the third command about whether the respective storage area configured for data in the process of executing the program requires power loss protection having changed compared to the first command.

In some implementations, the method may include receiving a fourth command. In some implementations, the fourth command may instruct to obtain the power loss protection capability of the computational storage system. In some implementations, the method may include updating the information related to the power loss protection capability of the computational storage system based on time required to execute the program and an aging speed of a power loss protection hardware of the computational storage system carried in the fourth command.

In some implementations, the method may include receiving a fifth command. In some implementations, the fifth command may instruct to set a condition for triggering an asynchronous event to be that the power loss protection capability of the computational storage system is lower than a preset threshold. In some implementations, the method may include receiving a sixth command. In some implementations, the sixth command may instruct to request the asynchronous event. In some implementations, the method may include sending an asynchronous event report based on the power loss protection capability of the computational storage system being lower than the preset threshold.

In some implementations, the method may include receiving a seventh command. In some implementations, the method may include, in response to the seventh command, performing an update operation on the information about whether the respective storage area in the first memory configured for data in the process of executing the program requires power loss protection.

In some implementations, the method may include, when the computational storage system is in a state of power loss, storing data in the storage area that requires power-loss protection into a first area of a second memory coupled to a controller of the computational storage system based on the information carried in the first command indicating that power-loss protection on the respective storage area is required.

In some implementations, the method may include, when power of the computational storage system is restored, storing the data that is stored into the first area of the second memory into the first memory or into a second area of the second memory based on an indication from a host coupled to the computational storage system.

In the technical solution provided by the present disclosure, the first command received by the controller carries information about whether the respective storage area requires power-loss protection, and the controller performs a power-loss protection operation on the storage area that requires power-loss protection when the computational storage system is in a state of power loss based on information carried in the first command indicating that power-loss protection on the respective storage area is required, so that important intermediate data can be protected when power loss occurs, and the influence of data loss caused by unexpected power loss is reduced.

### BRIEF DESCRIPTION OF DRAWINGS

FIG. 1 is a first schematic structural diagram of an electronic system, according to an example of the present disclosure;

FIG. 2 is a first schematic structural diagram of a computational storage, system according to an example of the present disclosure;

FIG. 3 is a schematic diagram of an example of loading a program in an electronic system, according to an example of the present disclosure;

FIG. 4 is a schematic diagram of an example of program execution in an electronic system, according to an example of the present disclosure;

FIG. 5 is a schematic diagram of a memory range and a memory range set, according to an example of the present disclosure;

FIG. 6 is a second schematic structural diagram of a computational storage system, according to an example of the present disclosure;

FIG. 7 is a first schematic diagram of interaction between a host and a computational storage system, according to an example of the present disclosure;

FIG. 8 is a second schematic diagram of interaction between a host and a computational storage system, according to an example of the present disclosure;

FIG. 9 is a third schematic structural diagram of a computational storage system, according to an example of the present disclosure;

FIG. 10 is a second schematic structural diagram of an electronic system, according to an example of the present disclosure;

FIG. 11 is a schematic flowchart of a method of operating a computational storage system, according to an example of the present disclosure.

### DETAILED DESCRIPTION

Exemplary implementations disclosed in the present disclosure will be described in more detail below with reference to the accompanying drawings. Although exemplary implementations of the present disclosure are shown in the accompanying drawings, it is to be understood that the present disclosure may be implemented in various forms and should not be limited to the implementations set forth herein. Rather, these implementations are provided so that the present disclosure can be more thoroughly understood and the scope disclosed in the present disclosure can be fully conveyed to those skilled in the art.

In the following description, numerous details are given in order to provide a more thorough understanding of the present disclosure. However, it will be apparent to one skilled in the art that the present disclosure may be practiced without one or more of these details. In other examples, in order to avoid confusion with the present disclosure, some technical features known in the art are not described; that is, not all features of the actual examples are described here, and well-known functions and structures are not described in detail.

In the drawings, like reference numerals refer to like elements throughout.

It should be understood that spatial relation terms such as “beneath,” “below,” “lower,” “under”, “above,” “upper,” etc., may be used herein for ease of description to describe the relationship between one element or feature and other elements or features shown in the figures. It should be appreciated that in addition to the orientations shown in the figures, the spatial relation term intent to also include different orientations of the devices in use and operation. For example, if the devices in the figures are flipped, then described as “below” or “under” or “beneath” other elements or features will be oriented “on” other elements or features. Thus, the exemplary terms “below” and “under” may include both upper and lower orientations. The devices may be additionally oriented (rotated 90 degrees or other orientations) and the spatial description terminology used herein is interpreted accordingly.

A term used herein is for the purpose of describing a specific examples only and is not to be considered as limitation of the present disclosure. As used herein, the singular forms “a”, “an” and “said/the” are intended to include the plural forms as well, unless the context clearly dictates otherwise. It should also be understood that the terms “consists of” and/or “comprising”, when used in this description, identify the presence of stated features, integers, steps, operations, elements and/or parts, but do not exclude the presence or addition of one or more other features, integers, steps, operations, elements, parts and/or groups. As used herein, the term “and/or” includes any and all combinations of the associated listed items.

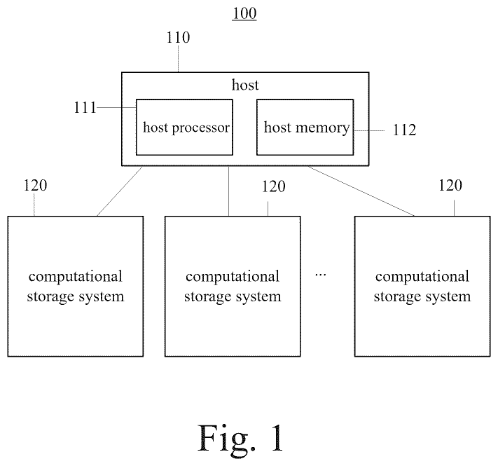

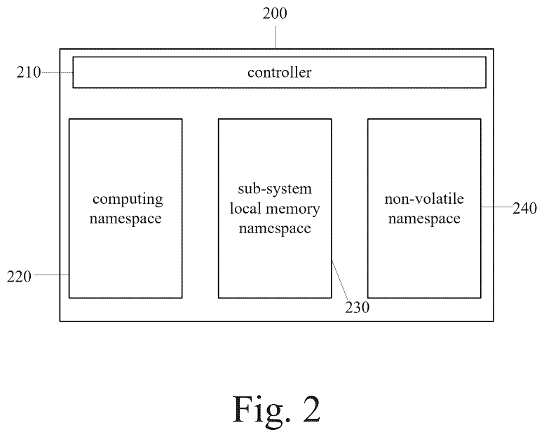

FIG. 1 is a schematic structural diagram of an electronic system according to an example of the present disclosure. FIG. 2 is a schematic structural diagram of a computational storage system according to an example of the present disclosure.

Referring to FIG. 1, an electronic system 100 may include a host 110 and at least one computational storage system 120. The host 110 may include a host processor 111 and a host memory 112. The host processor 111 may control the overall operation of the host 110. The host processor 111 may be implemented as at least one of various processing units (e.g., a central processing unit (CPU), an application processor (AP), a graphics processing unit (GPU), a neural processor unit (NPU), a field programmable gate array (FPGA), and/or a microprocessor). In some examples, the host processor 111 may be implemented as a system on chip (SoC). The host memory 112 may store data, instructions, and programs needed for the operation of the host processor 111. The host memory 112 may be a volatile memory. Volatile memory may include, but is not limited to, random access memory (RAM), dynamic random access memory (DRAM), static random access memory (SRAM), synchronous dynamic random access memory (SDRAM), double data rate synchronous dynamic random access memory (DDR SDRAM).

The computational storage system 120 may be a semiconductor device that provides computing services and data storage services. The computational storage system 120 may be used as both a data storage in the electronic system 100 and a computing device for executing programs. In some examples, for example, the computational storage system 120 may be implemented as part of a data center or artificial intelligence training data device.

In some examples, host 110 and computational storage system 120 may be physically connected through an interface and comply with corresponding peripheral component interconnect express (PCIe)/non-volatile memory express (NVMe) protocol communications. For example, the host 110 and the computational storage system 120 may be connected through a network link, for example, based on an NVMe-over fabrics (OF) (NVMe-OF) protocol connection. For example, the host 110 and the computational storage system 120 may also be connected through a compute express link (CXL) interface, and the host 110 may control the operation of the computational storage system 120 via a compute express link (CXL) interface. The computational storage system 120 is configured to comply with the computational storage protocol of NVMe. The CXL interface may include CXL. io, CXL. cache, and CXL. mem as sub-protocols. The host 110 may load a predetermined program to the computational storage system 120 for processing. The host 110 may load various types of programs, such as applications, kernels, and/or computations, to the computational storage system 120. The program may include, for example, an encryption program, a compression program, an image recognition program, a filter program, and/or an artificial intelligence program.

Referring to FIG. 2, in some examples, the computational storage system 200 may include a controller 210, one or more sub-system local memory namespaces (SLM NS) 230, one or more non-volatile memory namespaces (NVM NS) 240, and one or more computing namespaces (CNS) 220. The computational storage system 200 may correspond to one of the plurality of computational storage systems 120 shown in FIG. 1. The sub-system local memory namespace 230 may be a namespace implemented by volatile memory that is closer to the computing processing components of the computing namespace 220 relative to the namespace implemented by the non-volatile memory. Non-volatile namespace 240 may be a namespace implemented by a non-volatile memory.

In some examples, the computational storage system 200 may use an NVMe protocol as a memory protocol, and the controller 210 may be an NVMe controller. The controller 210 may store input data/output data in a process of executing a program into the sub-system local memory namespace 230 and/or read input data/output data stored in the sub-system local memory namespace 230 in response to an input/output (I/O) request from the host.

In some examples, the controller 210 may execute various operations for controlling the non-volatile namespace 240 or other non-volatile memory. For example, various operations may include address-mapping operations, wear-leveling operations, and/or garbage-collection operations. The address-mapping operation may be a translation operation between a logical address managed by the host or controller and a physical address of the non-volatile namespace 240. Wear leveling may be an operation of equalizing the use frequency or number of multiple memory blocks included in the non-volatile namespace 240. The garbage-collection operation may be an operation of copying valid data from the source block of the non-volatile namespace 240 to the target block and then erasing the source block to ensure the available blocks or free blocks in the non-volatile namespace 240.

In some examples, the computing namespace 220 may be used as an abstraction that represents one or more computing engines for executing programs. The computing engine resources may be composed of one or more of a CPU, an FPGA, a GPU, an ASIC, or the like. For example, the computing namespace may include a CPU core and an FPGA. The computing engine resource may be part of the controller 210, or may be part independent of the controller 210. The computing engine may execute a program pre-loaded from the host. In some examples, the program may be stored in a program slot. Program slot may be formed in the computing engine, or may be allocated in separate memory. In some examples, a program slot in which a program is stored may be within the computing namespace 220, or may form a computing namespace 220, which is an entity capable of executing programs. The computing namespace 220 may be, for example, an entity in an NVMe sub-system. The computing namespace 220 may access the sub-system local memory namespace 230. In some examples, the computational storage system 200 may include one or more computing namespaces 220. If the computational storage system 200 includes multiple computing namespaces 220, the host may load plurality of programs to multiple computing namespaces 220 (e.g., in a one-to-one relationship), respectively. Thus, each loaded program may be managed in a respective computing namespace 220, and the present disclosure is not limited thereto.

In some examples, the controller 210 may copy the data stored in the non-volatile namespace 240 to the sub-system local memory namespace 230, and/or may copy the data stored in the sub-system local memory namespace 230 to the non-volatile namespace 240, that is, the controller 210 may control the data migration of the non-volatile namespace 240 and the local memory namespace 230 according to the need for program processing of the computing namespace 220.

The sub-system local memory namespace 230 may store input data to be used by programs to be executed, or may store results (output data) obtained from executing programs. In some examples, the sub-system local memory namespace 230 may also be accessed by the controller 210. The sub-system local memory namespace 230 may be implemented, for example, as DRAM.

In some examples, the controller 210 may also include a first control portion (not shown) that controls the sub-system local memory namespace 230, e.g., such as a cache controller. In some examples, the first control portion may be disposed as a chip separate from the controller 210. In some other examples, the first control portion may be disposed as an internal component of the controller 210.

Non-volatile namespace 240 may store input data/output data in a process of executing a program. Non-volatile namespace 240 may include, for example, flash memory such as NAND flash memory. In another example, the non-volatile namespace 240 may include, for example, phase change memory, resistive memory, magnetoresistive memory, ferroelectric memory, or polymer memory. In some examples, the computational storage system 200 may also include a second control portion, such as a flash controller, that controls or is configured to control the non-volatile namespace 240, which may be included in the controller 210.

In the examples of the present disclosure, the computing processing component in the computational storage system includes a computing engine resource that is abstracted into one or more computing namespaces for use by a user. A RAM inside the computing processing component in the computational storage system, a common RAM inside the computational storage system, and a RAM inside the controller may all be abstracted into a sub-system local namespace to be provided to the user for use. For a user, these computing namespaces and the sub-system local memory namespaces are in a parallel relationship; and in some implementations, the user may be informed that a certain sub-system local memory namespace is used by a certain computing namespace (because of a physical dependency) according to an internal physical implementation.

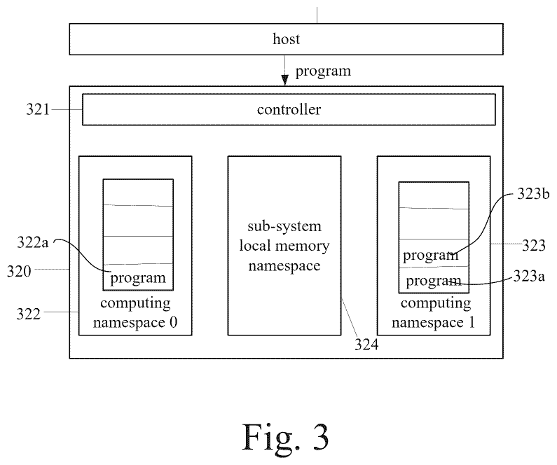

FIG. 3 is a schematic diagram of an example of loading a program in an electronic system, according to an example of the present disclosure.

Referring to FIG. 3, a host 310 may load a program to a computational storage system 320. In FIG. 3, the computational storage system 320 is shown to include a computing namespace 322 and a computing namespace 323 (e.g., computing namespaces 0 and 1), but the number of computing namespaces is not limited thereto.

In some examples, the computing namespace 322 and computing namespace 323 may support device-defined programs and/or downloadable programs. The device-defined program may be, for example, a fixed program provided by a manufacturer, and the downloadable program may be a program loaded into the computing namespace 322 and the computing namespace 323 by the host 310. For example, the device-defined program 323a may be configured in the computing namespace 323.

In some examples, the controller 321 of the computational storage system 320 may receive the programs 322a and 323b transmitted from the host 310 and store in the computational storage system 320. In response to program execution commands from the host 310, the computing engine of the computing namespace may execute programs 322a, 323a, and/or 323b in the computing namespace 322 and computing namespace 323 using input data stored in the sub-system local memory namespace 324, which may be respective input parameters required for program execution, and/or the like.

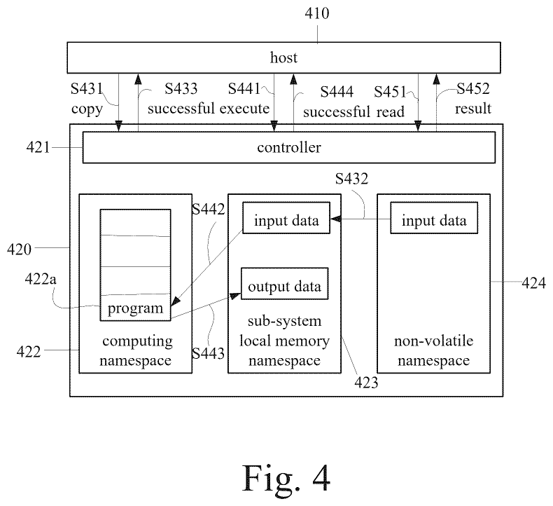

FIG. 4 is a schematic diagram of an example of program execution in an electronic system according to an example of the present disclosure. In FIG. 4, assume that program 422a is loaded into computing namespace 422 of computational storage system 420.

Referring to FIG. 4, at operation S431, the host 410 may send a data copy command to the controller 421 of the computational storage system 420. At operation S432, in response to the data copy command, input data stored in non-volatile memory namespace 424 (e.g., non-volatile memory device) may be copied to sub-system local memory namespace 423. In some examples, the controller 421 may control the non-volatile namespace 424 and the sub-system local memory namespace 423 in response to the data copy command to transfer input data from the non-volatile namespace 424 to the sub-system local memory namespace 423.

It should be noted that FIG. 4 is only an example, and is not intended to limit the transmission path of the input data and the output data in the examples of the present disclosure. In some examples, the host 410 may directly write the input data into the sub-system local memory namespace 423, and the output data obtained after the input data is processed by the program is stored into the sub-system local memory namespace 423, and the host 410 may directly obtain the output data from the sub-system local memory namespace 423; that is, the non-volatile namespace 424 may not be involved in the storage of input data and the storage of output data.

In some other examples, the non-volatile namespace 424 may also be involved in the storage of input data and the storage of output data. The host 410 may write the input data into the non-volatile namespace 424. The non-volatile namespace 424 copies the input data to the sub-system local memory namespace 423. The output data obtained after the input data is processed by the program is stored in the sub-system local memory namespace 423. The output data in the sub-system local memory namespace 423 is copied into the non-volatile namespace 424; and the host may obtain the output data from the non-volatile namespace 424.

In still other examples, the non-volatile namespace 424 may only be involved in one of the storage of input data and the storage of output data. For example, the host 410 may directly write the input data into the sub-system local memory namespace 423. The output data obtained after the input data is processed by the program is stored into the sub-system local memory namespace 423. The output data in the sub-system local memory namespace 423 is copied into the non-volatile namespace 424, and the host 410 may obtain the output data from the non-volatile namespace 424.

Additionally and/or alternatively, the host 410 may write the input data into the non-volatile namespace 424. The input data in the non-volatile namespace 424 is copied to the sub-system local memory namespace 423. The output data obtained after the input data is processed by the program is stored in the sub-system local memory namespace 423; and the host 410 may directly obtain the output data from the sub-system local memory namespace 423.

After copying data from NVM namespace 424 to the sub-system local memory namespace 423, at operation S433, controller 421 may send a read success message to host 410.

To execute the program, at operation S441, the host 410 may send program execution commands to the computational storage system 420 to execute the program 422a in the computing namespace 422. In some examples, the controller 421 may receive program execution commands from the host 410. At operation S442, in response to the program execution command, the computing engine in the computing namespace 422 may execute the program 422a in the computing namespace 422 using the input data stored in the sub-system local memory namespace 423. At operation S443, the computing namespace may store the execution result (output data) of the program 422a into the sub-system local memory namespace 423. After the execution of the program 422a in the computing namespace 422 is completed, at operation S444, the controller 421 may send a message indicating successful execution of the program to the host 410.

In some examples, at operation S451, the host 410 may send a read command indicating to read output data from the sub-system local memory namespace 423 to the computational storage system 420. At operation S452, the controller 421 may read the output data (e.g., the execution result of the program 422a) from the sub-system local memory namespace 423 and transmit the data to the host 410.

In some examples, after the execution of the program 422a is completed, the output data may be flushed down from the sub-system local memory namespace 423 to the non-volatile namespace 424.

The electronic system may execute programs on the computational storage system 420 by performing the operations described above. Further, if requested by the host 410, the electronic system may provide execution results of the program from the computational storage system 420 to the host 410.

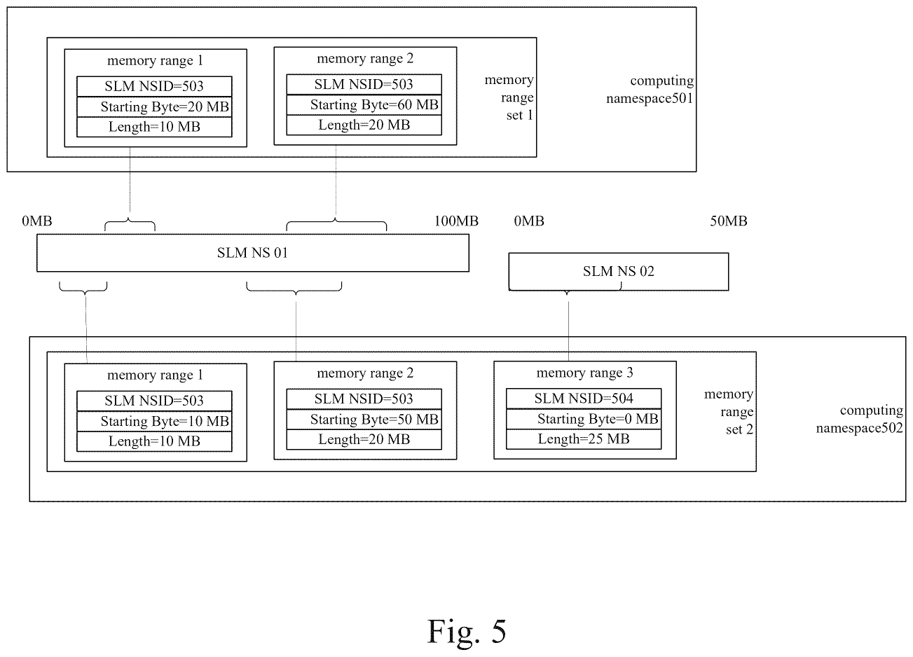

In some examples, the controller 421 configures a respective storage area in the memory of the sub-system local memory namespace 423 for storing the input data/output data in the process of executing a program in response to a command of the host. In some examples, the controller may configure a respective storage area by creating a memory range, where one memory range (MR) may define one corresponding storage area, the memory range may be represented by a sub-system local memory (SLM) namespaces (NS) identity (ID) (SLM NS ID), a starting byte of the storage area in the local memory namespace, and a length, and each memory range may specify a range in which the sub-system local memory namespace may be accessed. A set of memory ranges constitutes a memory range set (MRS). The memory range set may be stored in a computing namespace, each execution of the program being limited to accessing a range other than the range specified by the memory range set in the program name. As shown in FIG. 5, the memory range 1 and the memory range 2 in the computing namespace 501 constitute a memory range set 1; and the memory range 1, the memory range 2, and the memory range 3 in the computing namespace 502 constitute a memory range set 2. Each memory range includes information related to an SLM NS ID, a starting byte of the storage area in the local memory namespace, and a length. One area in the sub-system local memory namespace corresponding to the memory range may be obtained by the information included in the memory range. It should be noted that an example in which the memory range set is stored in the computing namespace is used as an example for description in FIG. 5, but the examples of the present disclosure are not limited thereto, and the memory range set may also be stored in other memories having a storage function of the computational storage system.

All input data/output data in a process of executing a program is stored in the sub-system local memory namespace, and for a program or a plurality of programs that require to be executed for a long time, if an unexpected power loss occurs, the data in sub-system local memory namespace is lost, the program requires to be re-executed, and the program execution efficiency is affected.

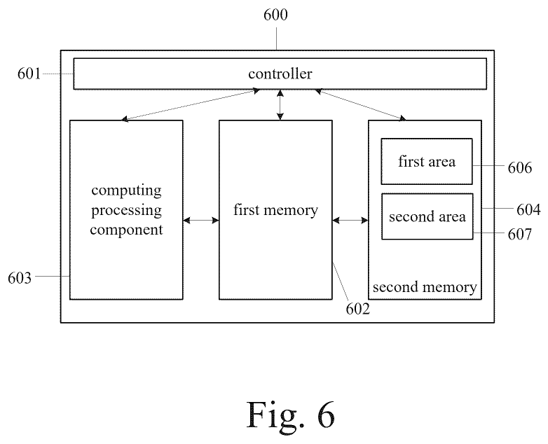

The present disclosure provides a computational storage system, as shown in FIG. 6. The computational storage system 600 may include a controller 601, a first memory 602 coupled to the controller 601, and a computing processing component 603 configured to execute a program. The controller 601 is configured to: receive a first command; in response to the first command, configure a respective storage area in the first memory 602 for data in a process of executing the program by the computing processing component 603; and perform a power-loss protection operation on the storage area that requires power-loss protection when the computational storage system 600 is in a state of power loss based on information carried in the first command indicating that power-loss protection on the respective storage area is required.

In the examples of the present disclosure, the first command received by the controller 601 carries information about whether the respective storage area requires power-loss protection; and the controller 601 performs a power-loss protection operation on the storage area that requires power-loss protection when the computational storage system 600 is in a state of power loss based on information carried in the first command indicating that power-loss protection on the respective storage area is required. In this way, important intermediate data may be protected when power loss occurs, and the influence of data loss caused by unexpected power loss is reduced.

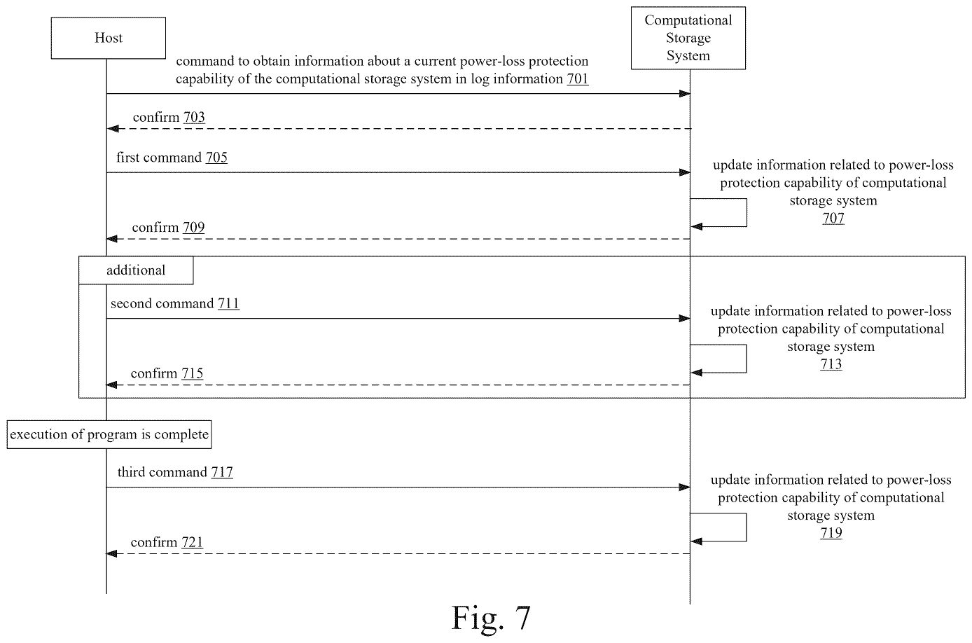

In some examples, referring to operation 705 in FIG. 7, the controller in the computational storage system is configured to receive a first command, where the first command may be a command to create a memory range set, the first command carries a memory range identity (MRID) and information about whether requires power-loss protection on the respective storage area. Here, the information indicating whether power-loss protection is required on the respective storage area may be bundled to the MRID of the respective storage area to instruct the computational storage system to protect the data in the identified storage area.

In some examples, the information indicating whether power-loss protection is required on the respective storage area may be directly included in the first command.

In some examples, the information about whether requires power-loss protection on the respective storage area may also be stored in the buffer in the host, the first command carries the pointer information, the pointer information points to a segment in the buffer in the host that stores the information about whether requires power-loss protection on the respective storage area, and the controller may parse to obtain the information about whether requires power-loss protection on the respective storage area.

For example, the first command is a command to create a memory range set. Pointer information of the command to create the memory range set points to a first area in the buffer in the host. The first area may be an area allocated for a memory range descriptor. A storage area that may be accessed in the sub-system local memory namespace may be specified according to a description in the memory range descriptor. For example, the capacity size of the first area may be a size of m bytes, the first n bytes (including the n-th byte) in the m bytes may sequentially record an identification number of sub-system local memory namespace to which the storage area belongs, a data length of the storage area, and a starting address of the storage area in the local memory namespace, where the (n+1)-th byte in the first area may be used to record the information about whether requires power-loss protection on the respective storage area, and the (n+2)-th byte to the m-th byte in the first area may be reserved for use.

In some examples, the first memory 602 is a volatile memory including, but not limited to, a random access memory (RAM), a dynamic random access memory (DRAM), a static random access memory (SRAM), a synchronous dynamic random access memory (SDRAM), a double data rate synchronous dynamic random access memory (DDR SDRAM). The computing processing component 603 has a computing function including, but not limited, to a computing engine, and the computing engine resource may be composed of one or more of a CPU, an FPGA, a GPU, or the like. The computing processing component may be a part of the controller or a part independent of the controller.

The computational storage system in the examples of the present disclosure supports a power-loss protection (PLP) function, and the power-loss protection function may be implemented by adding related hardware such as a capacitor and a power supply to maintain sufficient power for the computational storage system, but the present disclosure is not limited thereto.

In some examples, the controller 601 is configured to: update information related to a power-loss protection capability of the computational storage system 600 based on information about a current power-loss protection capability of the computational storage system 600 in log information of the computational storage system 600 and the information carried in the first command indicating that power-loss protection on the respective storage area is required.

Referring to FIG. 7, at operation 701, the host may send, to the computational storage system, a command to obtain the information about a current power-loss protection capability of the computational storage system in log information of the computational storage system.

At operation 703, the controller may send, to the host, a message indicating that obtaining the information about a current power-loss protection capability of the computational storage system in log information of the computational storage system is confirmed.

At operation 705, the controller in the computational storage system is configured to receive the first command sent by the host, where the first command may be a command to create a memory range set.

At operation 707, the controller updates information related to a power-loss protection capability of the computational storage system 600 based on information about a current power-loss protection capability of the computational storage system 600 in log information of the computational storage system and the information carried in the first command indicating that power-loss protection on the respective storage area is required.

At operation 709, the controller may send, to the host, a message indicating that the creation of memory range set is successfully confirmed, where the message indicating that the creation of memory range set is successfully confirmed may carry the identifier of the memory range set.

In some examples, the controller 601 is configured to: receive a second command; update the information related to the power-loss protection capability of the computational storage system 600 based on information carried in the second command that is related to an area range that requires power-loss protection in the storage area that requires power-loss protection, and perform the power-loss protection operation on the respective storage area based on the information carried in the second command that is related to the area range that requires power-loss protection in the storage area that requires power-loss protection and priority.

In some examples, the information related to the area range that requires power-loss protection in the storage area that requires power-loss protection including: an offset value of a starting address of an area that requires power-loss protection in the storage area that requires power-loss protection relative to a starting address of the storage area, and a size of data that may be stored in the area that requires power-loss protection in the storage area that requires power-loss protection.

For example, referring to FIG. 7, at operation 711, the controller receives a second command sent by the host, where the second command may be a command to set memory range (MR) feature, the second command carries the information related to the area range that requires power-loss protection in the storage area that requires power-loss protection, and carries a priority that requires power-loss protection on the storage area that requires power-loss protection, and the second command may further carry an identifier of a memory range corresponding to the storage area that requires power-loss protection.

At operation 713, update the information related to the power-loss protection capability of the computational storage system based on information carried in the second command that is related to an area range that requires power-loss protection in the storage area that requires power-loss protection.

At operation 715, the controller may send, to the host, a message indicating that the set memory range feature is successfully confirmed.

Herein, the priority that requires power-loss protection on the storage area that requires power-loss protection may include a first level priority and a second level priority, where the first level priority is used to indicate a degree of power-loss protection required on the data of the plurality of storage areas when all data of the plurality of storage areas requires power-loss protection. For example, the computational storage system must perform power-loss protection on the data of the storage area with the higher first level priority, and the computational storage system may perform power-loss protection on the data of the storage area with the lower first level priority as best.

The second level priority is used to indicate the order of performing power-loss protection on the plurality of storage areas with the same first level priority when the plurality of storage areas with the same first level priority require power-loss protection. For example, the computational storage system may first refresh the data in the storage area with the higher second level priority in the plurality of storage areas with the same first level priority down to the non-volatile memory device, and then refresh the data in the storage area with the lower second level priority in the plurality of storage areas with the same first level priority down to the non-volatile memory device. The first level priority and the second level priority may be configured by the host according to the degree of importance of the data stored in the corresponding storage area and the power-loss protection capability provided by the computational storage system.

In the examples of the present disclosure, the controller performs the power-loss protection operation on the respective storage area based on the information carried in the second command that is related to the area range that requires power-loss protection in the storage area that requires power-loss protection and priority. That is, the controller may perform power-loss protection on a certain segment of the storage area that requires power-loss protection and provide the priority that requires power-loss protection on the storage area that requires power-loss protection. In this way, the computational storage system may perform power-loss protection on identified data in the storage area that requires power-loss protection in the power loss scenario.

In some examples, the controller 601 is configured to: receive a third command based on the execution of the program being completed, where the third command carries information indicating that the respective storage area does not require power-loss protection; and update the information related to the power-loss protection capability of the computational storage system 600 based on corresponding information carried in the third command about whether the respective storage area configured for data in the process of executing the program requires power-loss protection having changed compared to the first command.

For example, referring to FIG. 7, at operation 717, when the execution of the program is completed, the controller receives a third command sent by the host, where the third command may be a command to set a memory range feature; the third command carries an identifier of the memory range, and carries information that does not require power-loss protection on the respective storage area.

At operation 719, the controller updates the information related to the power-loss protection capability of the computational storage system 600 based on corresponding information carried in the third command about whether the respective storage area configured for data in the process of executing the program requires power-loss protection having changed compared to the first command.

At operation 721 the controller may send, to the host, a message indicating that the set memory range feature is successfully confirmed, where the message indicating that the set memory range feature is successfully confirmed may carry the identifier of the memory range set.

In the examples of the present disclosure, when the execution of the program is completed, the information about performing power-loss protection on the respective storage area is set to not require power-loss protection, the setting of power-loss protection on the respective storage area is canceled, and the power-loss protection resource occupied by the storage area related to the program may be saved.

In some examples, the controller 601 is configured to: receive a fourth command, where the fourth command instructs to obtain the power-loss protection capability of the computational storage system 600; and update the information related to the power-loss protection capability of the computational storage system 600 based on time required to execute the program and an aging speed of a power-loss protection hardware of the computational storage system 600 carried in the fourth command.

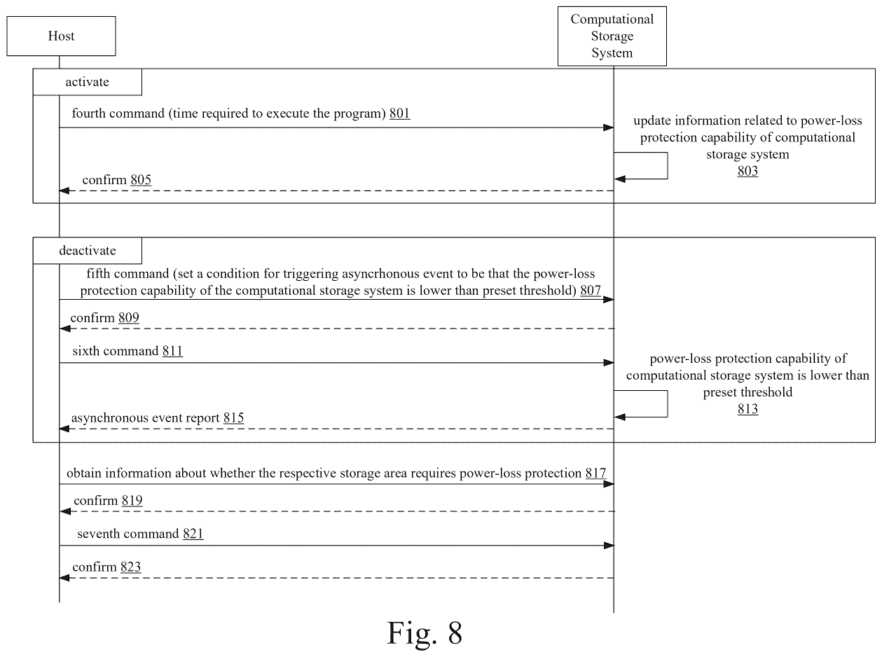

Referring to FIG. 8, at operation 801, the controller receives a fourth command sent by the host, where the fourth command instructs to obtain the power-loss protection capability of the computational storage system 600, the fourth command carries the time required to execute the program, and the time required to perform power-loss protection on the storage area configured for the data in the process of executing the program may be obtained according to the time required to execute the program.

At operation 803, the controller updates the information related to the power-loss protection capability of the computational storage system 600 based on time required to execute the program and an aging speed of a power-loss protection hardware of the computational storage system 600 carried in the fourth command, so as to estimate the power-loss protection capability of the computational storage system 600 when the execution of the program is completed.

At operation 805, the controller may send, to the host, a message indicating that obtaining the power-loss protection capability of the computational storage system 600 is successfully confirmed, where the message indicating that obtaining the power-loss protection capability of the computational storage system 600 is successfully confirmed carries information related to the power-loss protection capability of the computational storage system 600.

In some examples, when the fourth command does not carry the time required to execute the program, the controller may obtain, according to the historical average execution time of the program, the time required to perform power-loss protection on the storage area configured for the data in the process of executing the program.

In some examples, the controller 601 is configured to: receive a fifth command, where the fifth command instructs to set a condition for triggering an asynchronous event to be that the power-loss protection capability of the computational storage system 600 is lower than a preset threshold; receive a sixth command, where the sixth command instructs to request the asynchronous event; and send an asynchronous event report based on the power-loss protection capability of the computational storage system 600 being lower than the preset threshold.

Referring again to FIG. 8, at operation 807, the controller receives a fifth command sent by the host, where the fifth command may be a command to set feature, where the fifth command instructs to set a condition for triggering an asynchronous event to be that the power-loss protection capability of the computational storage system 600 is lower than a preset threshold.

At operation 809, the controller may send a message indicating that the set feature is successfully confirmed to the host.

At operation 811, the controller receives a sixth command sent by the host, where the sixth command instructs to request an asynchronous event.

At operation 813, the controller confirms that the power-loss protection capability of the computational storage system 600 is lower than a preset threshold due to aging of the power-loss protection hardware (for example, a capacitor and a power supply).

At operation 815, the controller sends an asynchronous event report to the host based on the power-loss protection capability of the computational storage system 600 being lower than a preset threshold. In some examples, the preset threshold may be determined according to the number of currently configured storage areas that require power-loss protection.

In some examples, the controller 601 is configured to: receive a seventh command; in response to the seventh command, perform an update operation on the information about whether the respective storage area in the first memory 602 configured for data in the process of executing the program requires power-loss protection.

For example, referring to FIG. 8, at operation 817, the controller receives information sent by the host that obtains whether all the current storage areas require power-loss protection.

At operation 819, the controller may send, to the host, a message indicating that obtaining information about whether all the current storage areas require power-loss protection is successfully confirmed.

At operation 821, the controller receives a seventh command sent by the host, where the seventh command may be a command to set memory range feature, and the controller performs, in response to the seventh command, an update operation on the information about whether the respective storage area in the first memory 602 configured for data in the process of executing the program requires power-loss protection.

At operation 823, the controller may send, to the host, a message indicating that set memory range feature is successfully confirmed.

In an instance when the power-loss protection capability of the computational storage system is less than the preset threshold, power-loss protection may not be performed on the configured storage area that requires power-loss protection, and by operations 817-823 in FIG. 8, the update operation is performed on the information about whether the configured respective storage area requires power-loss protection, so that the important data in the storage area may be better protected.

It can be understood that, when the computational storage system uses the capacitor/power supply to support power-loss protection, the power of the capacitor/power supply gradually decreases with time; and when the program is executed for a long time, the capacitor/power supply may not support a respective power-loss protection on the configured storage area that requires power-loss protection after aging. In the examples of the present disclosure, the host may be notified by using an asynchronous event report, so as to reconfigure the information about whether the respective storage area requires power-loss protection, thereby further reducing the risk of data loss.

In some examples, as shown in FIG. 6, the computational storage system 600 may further include a second memory 604 coupled to the controller 601, and the controller 601 is configured to, when the computational storage system 600 is in a state of power loss, store data in the storage area that requires power-loss protection into a first area 606 of the second memory 604 based on the information carried in the first command indicating that power-loss protection on the respective storage area is required.

In some examples, the second memory is a non-volatile memory including, but not limited to, flash memory such as NAND flash memory, phase change memory, resistive memory, magnetoresistive memory, ferroelectric memory, or polymer memory.

In some examples, as shown in FIG. 6, the controller 601 is configured to: when the computational storage system 600 restores power, store the data stored into the first area 606 of the second memory 604 into the first memory 602 or in a second area 607 of the second memory 604.

In the examples of the present disclosure, when the computational storage system restores power, the controller may inform the host whether the data of the respective storage area is completely protected when in a state of power loss and the identifier of memory range of the respective storage area according to the log information, and the host determines whether to load the current protected data from the first area of the second memory into the other storage area of the first memory or refresh down to the second area in the second memory according to the identifier of the memory range.

In some examples, the log information may be stored in a second memory. The log information is a record of an event. The log information may be generated by a controller. The controller periodically inspects related hardware such as a capacitor or a power supply that implements a power-loss protection function in the computational storage system. The controller detects a power-loss protection capability of the capacitor or the power supply. The controller generates related log information, where the log information herein may be stored in a non-volatile memory device in the computational storage system.

In the examples of the present disclosure, when the power loss scenario occurs, the computational storage system may protect important data in the respective storage area. When the power is restored, the program may continue to calculate according to the protected important data, thereby avoiding the efficiency loss caused by the recalculation due to the loss of important data.

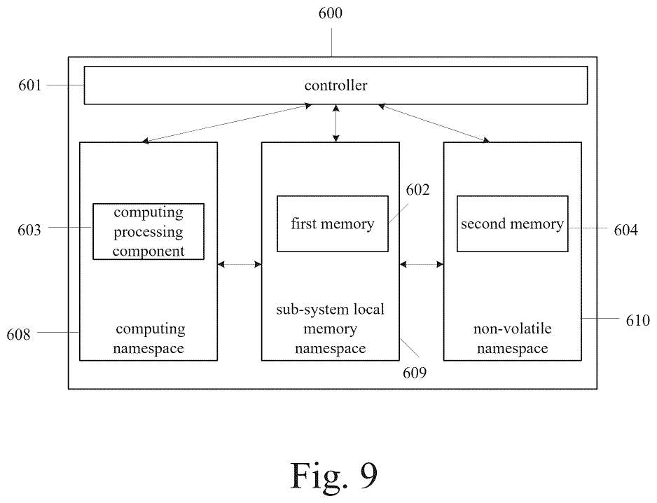

In some examples, as shown in FIG. 9, the computational storage system 600 may include a non-volatile namespace 610 including the second memory 604, a computing namespace 608 including the computing processing component 603, and a sub-system local memory namespace 609 including the first memory 602.

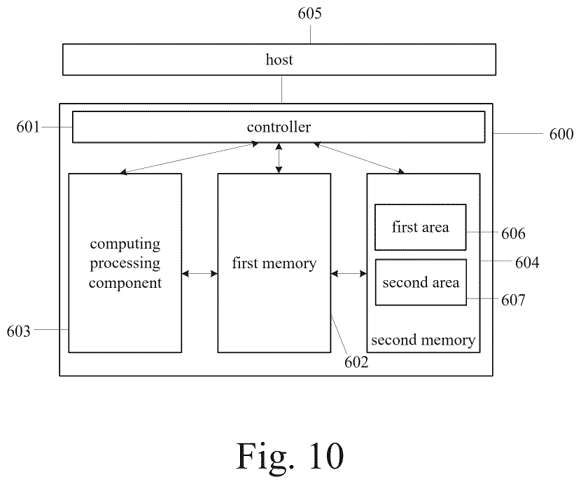

Based on the above-described computational storage system, an example of the present disclosure further provides an electronic system, as shown in FIG. 10. The electronic system may include a host 605 and a computational storage system 600 coupled to the host 605. The computational storage system 600 may include a controller 601, a first memory 602 coupled to the controller 601, and a computing processing component 603 configured to execute a program, where the host 605 is configured to: send a first command. The controller 601 may be configured to: receive the first command; in response to the first command, configure a respective storage area in the first memory 602 for data in a process of executing the program; and perform a power-loss protection operation on the storage area that requires power-loss protection when the computational storage system 600 is in a state of power loss based on information carried in the first command indicating that power-loss protection on the respective storage area is required.

In the examples of the present disclosure, the controller 601 receives the first command sent by the host, where the first command carries information about whether the respective storage area requires power-loss protection. The controller 601 performs a power-loss protection operation on the storage area that requires power-loss protection when the computational storage system 600 is in a state of power loss based on information carried in the first command indicating that power-loss protection on the respective storage area is required. In this way, important intermediate data may be protected when power loss occurs, and the influence of data loss caused by unexpected power loss is reduced.

In some examples, the host 605 is configured to: determine that whether the respective storage area requires power-loss protection based on information about a power-loss protection capability of the computational storage system 600 in obtained log information of the computational storage system 600 and degree of importance of data to be stored in the respective storage area; the controller 601 is configured to: update information related to a power-loss protection capability of the computational storage system 600 based on information about a current power-loss protection capability of the computational storage system 600 in log information of the computational storage system 600 and the information carried in the first command indicating that power-loss protection on the respective storage area is required.

In some examples, the host 605 is configured to: send a second command; the controller 601 is configured to: receive the second command; update the information related to the power-loss protection capability of the computational storage system 600 based on information carried in the second command that is related to an area range that requires power-loss protection in the storage area that requires power-loss protection, and perform the power-loss protection operation on the respective storage area based on the information carried in the second command that is related to the area range that requires power-loss protection in the storage area that requires power-loss protection and priority.

In some examples, the host 605 is configured to: send a third command based on the execution of the program being completed, where the third command carries information indicating that the respective storage area does not require power-loss protection; the controller 601 is configured to: receive the third command; and update the information related to the power-loss protection capability of the computational storage system 600 based on corresponding information carried in the third command about whether the respective storage area configured for data in the process of executing the program requires power-loss protection having changed compared to the first command.

In some examples, the host 605 is configured to: send a fourth command, where the fourth command instructs to obtain the power-loss protection capability of the computational storage system 600; the controller 601 is configured to: receive the fourth command; update the information related to the power-loss protection capability of the computational storage system 600 based on time required to execute the program and an aging speed of a power-loss protection hardware of the computational storage system 600 carried in the fourth command.

In some examples, the host 605 is configured to: send a fifth command, where the fifth command instructs to set a condition for triggering an asynchronous event to be that the power-loss protection capability of the computational storage system 600 is lower than a preset threshold; send a sixth command, where the sixth command instructs to request the asynchronous event; the controller 601 is configured to: receive the fifth command and the sixth command; and send an asynchronous event report based on the power-loss protection capability of the computational storage system 600 being lower than the preset threshold.

In some examples, the host 605 is configured to: send a seventh command; the controller 601 is configured to: receive the seventh command; and in response to the seventh command, perform an update operation on the information about whether the respective storage area in the first memory configured for data in the process of executing the program requires power-loss protection.

In some examples, as shown in FIG. 10, the computational storage system 600 may further include a second memory 604 coupled to the controller 601. The controller 601 is configured to: when the computational storage system 600 is in a state of power loss, store data in the storage area that requires power-loss protection into a first area 606 of the second memory 604 based on the information carried in the first command indicating that power-loss protection on the respective storage area is required.

In some examples, as shown in FIG. 10, the controller 601 is configured to: when the computational storage system 600 restores power, store the data stored into the first area 606 of the second memory 604 into the first memory 602 or in a second area 607 of the second memory 604.

Further details about the above electronic system are described in detail in the above examples of the computational storage system, and details are not described herein again for brevity.

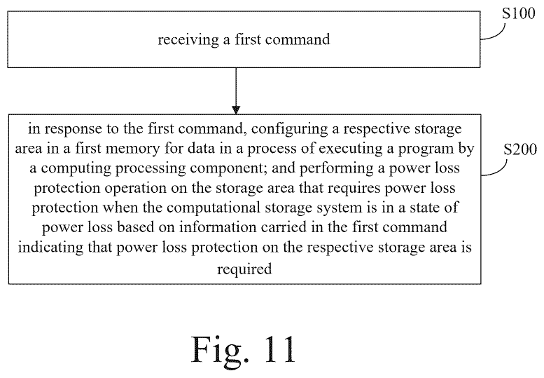

Based on the above computational storage system, an example of the present disclosure further provides a method of operating a computational storage system. As shown in FIG. 11, the method may include operations S100 and S200. At operation S100, a first command may be received. At operation S200, in response to the first command, a respective storage area may be configured in a first memory for data in a process of executing a program by a computing processing component. Also, at operation S200, a power-loss protection operation may be performed on the storage area that requires power-loss protection when the computational storage system is in a state of power loss based on information carried in the first command indicating that power-loss protection on the respective storage area is required.

In some examples, the method may further include updating information related to a power-loss protection capability of the computational storage system based on information about a current power-loss protection capability of the computational storage system in log information of the computational storage system and the information carried in the first command indicating that power-loss protection on the respective storage area is required.

In some examples, the method may further include receiving a second command; and updating the information related to the power-loss protection capability of the computational storage system based on information carried in the second command that is related to an area range that requires power-loss protection in the storage area that requires power-loss protection. The method may include performing the power-loss protection operation on the respective storage area based on the information carried in the second command that is related to the area range that requires power-loss protection in the storage area that requires power-loss protection and priority.

In some examples, the information related to the area range that requires power-loss protection in the storage area that requires power-loss protection may include an offset value of a starting address of an area that requires power-loss protection in the storage area that requires power-loss protection relative to a starting address of the storage area, and a size of data that may be stored in the area that requires power-loss protection in the storage area that requires power-loss protection.

In some examples, the method may include receiving a third command based on the execution of the program being completed, where the third command carries information indicating that the respective storage area does not require power-loss protection. The method may include updating the information related to the power-loss protection capability of the computational storage system based on corresponding information carried in the third command about whether the respective storage area configured for data in the process of executing the program requires power-loss protection having changed compared to the first command.

In some examples, the method may include receiving a fourth command, where the fourth command instructs to obtain the power-loss protection capability of the computational storage system. The method may include updating the information related to the power-loss protection capability of the computational storage system based on time required to execute the program and an aging speed of a power-loss protection hardware of the computational storage system carried in the fourth command.

In some examples, the method may include receiving a fifth command, where the fifth command instructs to set a condition for triggering an asynchronous event to be that the power-loss protection capability of the computational storage system is lower than a preset threshold; receiving a sixth command, where the sixth command instructs to request the asynchronous event. The method may include sending an asynchronous event report based on the power-loss protection capability of the computational storage system being lower than the preset threshold.

In some examples, the method may include receiving a seventh command. The method may include, in response to the seventh command, performing an update operation on the information about whether the respective storage area in the first memory configured for data in the process of executing the program requires power-loss protection.

In some examples, the method may include, when the computational storage system is in a state of power loss, storing data in the storage area that requires power-loss protection into a first area of a second memory coupled to a controller of the computational storage system based on the information carried in the first command indicating that power-loss protection on the respective storage area is required.

In some examples, the method may include, when power of the computational storage system is restored, storing the data that is stored into the first area of the second memory into the first memory or into a second area of the second memory based on an indication from a host coupled to the computational storage system.

The method of operating the computational storage system mentioned in the above examples is described in detail in the above examples related to the computational storage system, and details are not described herein again for brevity.

Based on the above method of operating the computational storage system, an example of the present disclosure further provides a computer-readable storage medium, where the computer-readable storage medium stores a computer program, and the computer program, when executed by a processor, implements the method of operating the computational storage system according to any one of the above examples.

Herein, all or part of the processes in the method of operating the computational storage system in the above examples are implemented by using a computer program for instructing related hardware, and the program may be stored in a computer-readable storage medium, and when the program is executed, the program may include the processes of the examples of the above methods. The storage medium may be a Ferromagnetic random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, an optical disc, or a compact disc read-only memory (CD-ROM), and the like; and the storage medium may further include a combination of the above types of memories.

The features disclosed in the several apparatus examples provided by the present disclosure may be arbitrarily combined without conflict to obtain a new apparatus example.

The method disclosed in the several method examples provided by the present disclosure may be arbitrarily combined without conflict to obtain a new method example.

The above description is only an example of the present disclosure, but the protection scope of the present disclosure is not limited thereto, and changes or replacements that may be easily conceived by any person skilled in the art within the technical scope of the present disclosure should be covered within the protection scope of the present disclosure.

What is claimed is:

1. A computational storage system, comprising:
a first memory;
a computing processing component configured to execute a program; and
a controller coupled to the first memory and configured to:
receive a first command;
in response to the first command, configure a respective storage area in the first memory for data in a process of executing the program by the computing processing component; and
perform a power-loss protection operation on the storage area that requires power-loss protection when the computational storage system is in a state of power loss based on information carried in the first command indicating that power-loss protection on the respective storage area is required.

2. The computational storage system of claim 1, wherein the controller is configured to:
update information related to a power-loss protection capability of the computational storage system based on information about a current power-loss protection capability of the computational storage system in log information of the computational storage system and the information carried in the first command indicating that power-loss protection on the respective storage area is required.

3. The computational storage system of claim 2, wherein the controller is configured to:
receive a second command;
update the information related to the power-loss protection capability of the computational storage system based on information carried in the second command that is related to an area range that requires power-loss protection in the storage area that requires power-loss protection; and
perform the power-loss protection operation on the respective storage area based on the information carried in the second command that is related to the area range that requires power-loss protection in the storage area that requires power-loss protection and priority.

4. The computational storage system of claim 3, wherein the information related to the area range that requires power-loss protection in the storage area that requires power-loss protection comprises:
an offset value of a starting address of an area that requires power-loss protection in the storage area that requires power-loss protection relative to a starting address of the storage area, and a size of data that can be stored in the area that requires power-loss protection in the storage area that requires power-loss protection.

5. The computational storage system of claim 1, wherein the controller is configured to:
receive a third command based on the execution of the program being completed, wherein the third command carries information indicating that the respective storage area does not require power-loss protection; and
update the information related to the power-loss protection capability of the computational storage system based on corresponding information carried in the third command about whether the respective storage area configured for data in the process of executing the program requires power-loss protection having changed compared to the first command.

6. The computational storage system of claim 2, wherein the controller is configured to:
receive a fourth command, wherein the fourth command instructs to obtain the power loss protection capability of the computational storage system; and
update the information related to the power loss protection capability of the computational storage system based on time required to execute the program and an aging speed of a power loss protection hardware of the computational storage system carried in the fourth command.

7. The computational storage system of claim 1, wherein the controller is configured to:
receive a fifth command, wherein the fifth command instructs to set a condition for triggering an asynchronous event to be that the power loss protection capability of the computational storage system is lower than a preset threshold;
receive a sixth command, wherein the sixth command instructs to request the asynchronous event; and
send an asynchronous event report based on the power loss protection capability of the computational storage system being lower than the preset threshold.

8. The computational storage system of claim 7, wherein the controller is configured to:
receive a seventh command;
in response to the seventh command, perform an update operation on the information about whether the respective storage area in the first memory configured for data in the process of executing the program requires power loss protection.

9. The computational storage system of claim 1, further comprising a second memory coupled to the controller, wherein the controller is configured to:
when the computational storage system is in a state of power loss, store data in the storage area that requires power-loss protection into a first area of the second memory based on the information carried in the first command indicating that power-loss protection on the respective storage area is required.

10. The computational storage system of claim 9, wherein the controller is configured to:
when power of the computational storage system is restored, store the data that is stored into the first area of the second memory into the first memory or into a second area of the second memory.

11. The computational storage system of claim 9, comprising:
a non-volatile namespace comprising the second memory;
a computing namespace comprising the computing processing component; and
a sub-system local memory namespace comprising the first memory.

12. An electronic system, comprising:
a host configured to:
send a first command; and
a computational storage system coupled to the host and comprising:
a first memory;
a computing processing component configured to execute a program; and
a controller coupled to the first memory and configured to:
receive the first command;
in response to the first command, configure a respective storage area in the first memory for data in a process of executing the program; and
perform a power-loss protection operation on the storage area that requires power-loss protection when the computational storage system is in a state of power loss based on information carried in the first command indicating that power-loss protection on the respective storage area is required.

13. The electronic system of claim 12, wherein:
the host is configured to:
determine whether the respective storage area requires power-loss protection based on information about a power-loss protection capability of the computational storage system in log information of the computational storage system and a degree-of-importance of data to be stored in the respective storage area; and
the controller is configured to:
update information related to a power-loss protection capability of the computational storage system based on information about a current power-loss protection capability of the computational storage system in the log information of the computational storage system and the information carried in the first command indicating that power-loss protection on the respective storage area is required.

14. The electronic system of claim 13, wherein:
the host is configured to:
send a second command, and
the controller is configured to:
receive the second command;
update the information related to the power-loss protection capability of the computational storage system based on information carried in the second command that is related to an area range that requires power-loss protection in the storage area that requires power-loss protection; and
perform the power-loss protection operation on the respective storage area based on the information carried in the second command that is related to the area range that requires power-loss protection in the storage area that requires power-loss protection and priority.

15. The electronic system of claim 12, wherein
the host is configured to:
send a third command based on the execution of the program being completed, wherein the third command carries information indicating that the respective storage area does not require power loss protection;
the controller is configured to:
receive the third command; and
update the information related to the power loss protection capability of the computational storage system based on corresponding information carried in the third command about whether the respective storage area configured for data in the process of executing the program requires power loss protection having changed compared to the first command.

16. The electronic system of claim 12, wherein
the host is configured to:
send a fourth command, wherein the fourth command instructs to obtain the power loss protection capability of the computational storage system;
the controller is configured to:
receive the fourth command; and
update the information related to the power loss protection capability of the computational storage system based on time required to execute the program and an aging speed of a power loss protection hardware of the computational storage system carried in the fourth command.

17. The electronic system of claim 12, wherein
the host is configured to:
send a fifth command, wherein the fifth command instructs to set a condition for triggering an asynchronous event to be that the power loss protection capability of the computational storage system is lower than a preset threshold; and
send a sixth command, wherein the sixth command instructs to request the asynchronous event;
the controller is configured to:
receive the fifth command and the sixth command; and
send an asynchronous event report based on the power loss protection capability of the computational storage system being lower than the preset threshold.

18. The electronic system of claim 17, wherein
the host is configured to:
send a seventh command;
the controller is configured to:
receive the seventh command; and
in response to the seventh command, perform an update operation on the information about whether the respective storage area in the first memory configured for data in the process of executing the program requires power loss protection.

19. A method of operating a computational storage system, comprising:
receiving a first command;
in response to the first command, configuring a respective storage area in a first memory for data in a process of executing a program by a computing processing component; and
performing a power-loss protection operation on the storage area that requires power-loss protection when the computational storage system is in a state of power loss based on information carried in the first command indicating that power-loss protection on the respective storage area is required.

20. The method of claim 19, further comprising:
updating information related to a power-loss protection capability of the computational storage system based on information about a current power-loss protection capability of the computational storage system in log information of the computational storage system and the information carried in the first command indicating that power-loss protection on the respective storage area is required.
